(19) United States
(12) Patent Application Publication
(10) Pub. No.: US 2011/0213745 A1
(43) Pub. Date: Sep. 1, 2011

(54) Ark of Knowledge

(76) Inventor: Harold James Willard, JR., Washington, DC (US)

(21) Appl. No.: 12/926,190

(22) Filed: Nov. 1, 2010

Related U.S. Application Data
(60) Provisional application No. 61/282,554, filed on Mar. 1, 2010.

(51) Int. Cl. G06N 5/02

(52) U.S. Cl. 706/50

(57) ABSTRACT

This invention uses existing technology in a novel way to create a repository in Antartica to hold samples of life on planet Earth. The purpose of the repository, which can be known as the Ark of Knowledge, is to provide an experimental database consisting of the remains of the human species, and others as deemed appropriate, with appropriate documentation, which future generations even ten thousand years from now can use to evaluate somatic and genetic changes in our species, and others, due to environmental or other causes.

### REFERENCE TO PRIOR APPLICATION

Provisional Application filed Mar. 1, 2010; Application No. 61/282,554; Confirmation No. 7050.

ARK OF KNOWLEDGE: A REPOSITORY FOR HUMAN REMAINS IN ANTARTICA Harold James Willard, Jr., Ben Franklin Station, P.O. Box 7892, Washington, D.C., 20044-7892.

### REFERENCES CITED

(1) National Geographic Picture Atlas of Our World, National Geographic Society, Washington, D.C., Mary B. Dickenson, Ed., 1993, pp. 256ff.
(2) Baerwald, Thomas J. and Fraser, Celeste, World Geography, Building a Global Perspective, Prentice Hall, Needham, Mass., 2000, p. 693.
(3) Life Pictorial Atlas, The Editors of Life and Rand McNally, Time Incorp., NY, 1961, p. 438ff.
(4) Antartica, Atkins, Edward G., and Engel, Larry, Office of Polar Programs and the Informal Science Program, National Science Foundation, Arlington, Va. 22230, 2001.
(5) Murray, Raymond L., Understanding Radioactive Waste, Battelle Memorial Institute, Columbus, Ohio, 2003.
(6) Caldicott, Helen, The New Nuclear Danger, George W. Bush's Military Industrial Complex, The New Press, New York, 2004, pp. 9-11.
U.S. Patent Documents: none found

### BACKGROUND OF THE INVENTION

Governments, universities, museums and other institutions, as well as individuals, are engaged in on-going studies of the evolution of life on planet Earth. The search for ancient remains of humans and other species has a dual purpose: to determine the origin of species, and to assess how our species, and others, have progressed over the millennia. This quest, which is apparently unique to our species, is essential for the preservation of our species, and, if mankind is the chief custodian for life on this planet, the survival of others, as well. (Or at least those comprising the higher forms of life.) When specimens of animal life are discovered in pyramids, burial mounds, bogs, deserts, under ice or elsewhere, great excitement is generated not only among scientists, but also among the general public worldwide. Such discoveries offer experimental evidence upon which theories can be evaluated and refined about who we are and why and where we are going.

A repository of well-preserved and well-documented remains of the human species, and others as deemed appropriate, from all nations and peoples could provide an experimental database of inestimable value to future generations even tens of thousands of years from now. Cooperating in such an ongoing venture could also help promote peace among nations.

Physical scientists, medical researchers and others would have an experimental database upon which to assess the effects of biological and chemical pollutants and radioactivity in our environment on our species over a period of time such that long-term genetic effects could become evident. Furthermore, the consequences of catastrophic events, such as wars, a meteor impact, a major radiation release, volcanic eruption, or rapid technological changes would be more evident with a sound experimental database upon which to evaluate them.

In the event that life on this planet should become unsustainable, an Ark of Knowledge could provide a cache of well-preserved specimens to be discovered by visitors, perhaps from a far-distant planet.

Such a repository must be located in a geographically stable location, not easily accessible to humans or other creatures in order to prevent its desecration. It should be in a location which does not require a man-made source of energy for its successful operation over a span of thousands of years. The Antartic continent satisfies these criteria.

Antartica is a hugh land mass covered by a thick layer of ice, whereas the Artic is a sea area covered by floating ice. Antartica comprises ten percent of the earth's land and 90% of the earth's ice, averaging about 3.2 KM (2 miles) thick. Winds of 320 KM/hr (200 mph) and temperatures to −121° F. (−85° C.) are recorded, greatly restricting human occupation. About forty research stations are scattered about the continent from various stations (FIG. 1). (References 1, 2, 3, 4). It appears likely to remain more stable than other locations on this planet and is probably least likely to be adversely affected by wars or other forms of man's intervention.

The Antartic Treaty, ratified by twelve nations in 1961, banned all military activity, all nuclear explosions, and all storage of radioactive waste on the continent. Antartica is to be used for peaceful purposes and scientific research results are to be shared. This treaty was re-ratified in 1991 by forty nations with the added provision that all mining and oil exploration are banned for fifty years. Among the various peaceful uses of Antartica are the study of climate, cosmic rays, the ozone layer, the water level of oceans, and the earth's past. An Ark of Knowledge is perfectly consistent with these activities and the Artic Treaty.

It seems likely that many individuals would offer their remains for such a project, just as many do now in offering their remains to provide organs for the living or medical school instruction.

The concept of storing material for ten thousand years has already been adopted by the United States government and others in the storage of high-level radioactive waste from nuclear power plants (Ref. 5). Unlike the items to be stored in the Ark of Knowledge, radioactive waste requires constant military protection to prevent its access by terrorists who could do immeasurable harm by dispersing such material in populated areas (Ref. 6).

The Ark of Knowledge poses no threat. Indeed, it offers great hope for the future of mankind and other creatures on planet Earth.

### BRIEF SUMMARY OF THE INVENTION

This invention uses existing technology in a novel way to develop a repository in Antartica to hold samples of life on planet Earth. The purpose of the repository, which can be known as the Ark of Knowledge, is to provide an experimental database consisting of the remains of the human species, and others as deemed appropriate, which future generations even ten thousand years from now can use to evaluate somatic and genetic changes in our species, and others, due to environmental or other causes.

Physical scientists, medical researchers and others will, through this invention, have an experimental database upon which to assess the effects of biological and chemical pollutants and radioactivity in our environment on our species over a period of time such that long-term genetic effects not recognizable over the span of a few lifetimes can become evident.

In the event that life on this planet should become unsustainable, an Ark of Knowledge can provide a cache of well-preserved specimens to be discovered by visitors, perhaps from a far-distant planet.

Such a repository must be located in a geographically stable location, not easily accessible to humans or other creatures in order to prevent its desecration. It should be in a location which does not require a man-made source of energy for its successful operation over a span of thousands of years. The Antartic continent satisfies these criteria.

The Ark of Knowledge is perfectly consistent with the Antartic Treatyof 1961, ratified in 1991, which limits the uses of Antartica to peaceful activities, such as the study of climate, the ozone layer, cosmic rays, the water level of oceans, and the earth's past.

It seems likely that many individuals would offer their remains for such a project, just as many do now in offering their remains to provide organs for the living or medical education.

The concept of storing material for thousands of years has already been adopted by the United States and other nations in the storage of high-level radioactive waste from nuclear power plants. Whereas such facilities require constant military protection to prevent access by terrorists to the extremely dangerous material in storage, the Ark of Knowledge poses no threat. Indeed, it offers great hope for the future of mankind and other creatures on planet Earth.

### DETAILS OF THE INVENTION

The purpose of the Ark of Knowledge is consistent with the provisions of the Antartic Treaty of 1961, ratified in 1991. However, international approval of signatory nations will be required before construction of the facility can commence.

In the interim, design specifications for the facility can be developed and possible locations can be evaluated by the United States as a signatory to serve as a starting point for discussions when approval is achieved.

Presentation to the public of the concept can be commenced and registration of those willing to donate their remains to the project can be obtained.

Once approval under the Antartic Treaty is obtained, collection of specimens can commence using the best scientific talent for such purposes, under criteria established by a group established for that purpose.

Interim storage of properly prepared specimens could be accomplished using catacombs cut into the ice until a facility is constructed.

The design of the facility should consider provisions for allowing tourists to visit the location for information and perhaps to view the remains of loved ones and ancestors interred in the facility.

### BRIEF DESCRIPTION OF THE FIGURES

FIG. 1. Schematic of Antartica depicting major geographic features and some of the permanent research stations. The Ark of Knowledge, proposed in this invention to be an ongoing repository for specimens of life on planet Earth for future generations to evaluate, should be located under a covering of ice over a stable land area, such as in the vicinity of the United States research station at the South Pole (The Amundsen-Scott Station).

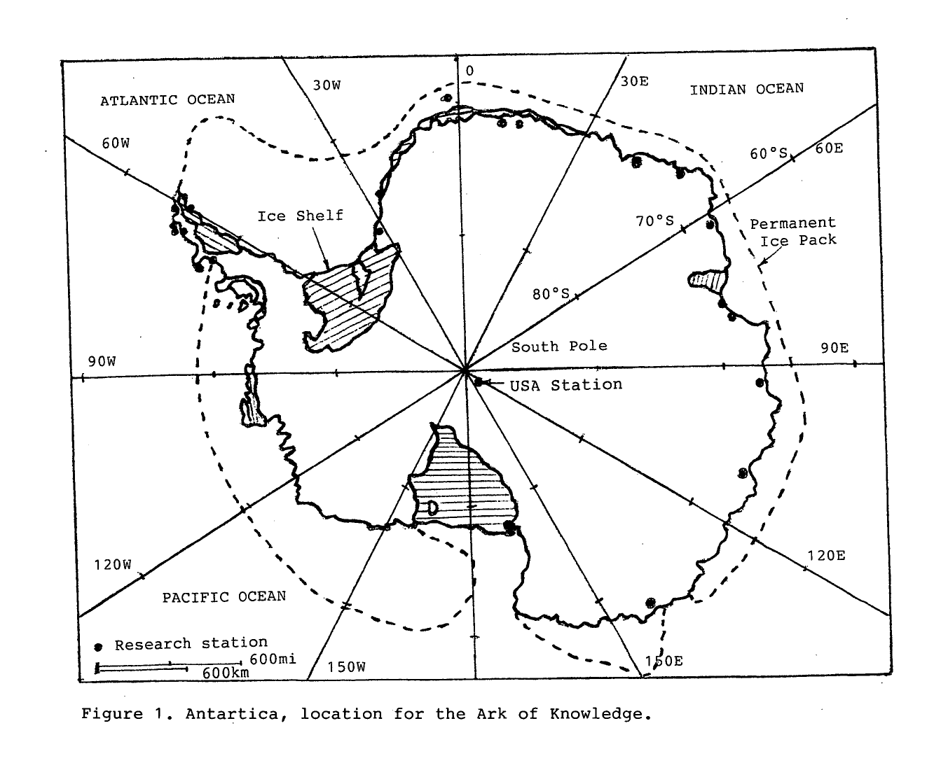

The claims of this invention are:

1. That a repository in Antartica for representative specimens of life on planet Earth is conceived;

2. That this repository, which can be known as the Ark of Knowledge, can provide future generations even thousands of years from now with an experimental database upon which to assess genetic and somatic changes in the human species, and others as deemed appropriate, due to environmental, catastrophic or other causes;

3. That this repository can provide the means by which physical scientists and medical researchers can determine if slowly developing long-term effects on the health and well-being of the human species, and others, as appropriate, are occurring, perhaps not discernible over periods of a few decades or centuries;
